(19) United States
(12) Patent Application Publication
(10) Pub. No.: US 2026/0071674 A1
(43) Pub. Date: Mar. 12, 2026

(54) VEHICLE

(71) Applicant: TOYOTA JIDOSHA KABUSHIKI KAISHA, Toyota-shi (JP)

(72) Inventors: Taro MOTEKI, Zama-shi (JP); Yoichiro ISAMI, Mishima-shi (JP); Tatsuya IMAMURA, Okazaki-shi (JP)

(73) Assignee: TOYOTA JIDOSHA KABUSHIKI KAISHA, Toyota-shi (JP)

(21) Appl. No.: 19/319,230

(22) Filed: Sep. 4, 2025

(30) Foreign Application Priority Data
Sep. 9, 2024 (JP) 2024-155168
Apr. 14, 2025 (JP) 2025-066122

(51) Int. Cl. F16H 59/02; B60L 15/20

(52) U.S. Cl. CPC F16H 59/0204; B60L 15/20; B60L 2260/20

(57) ABSTRACT

The present disclosure relates to a vehicle capable of switching a mode between a manual shift mode in which a driver performs gear shift operation and an automatic mode in which the driver does not need to perform gear shift operation. The vehicle comprises an alternate type shift selector used for selecting a shift position in the manual shift mode and a momentary type shift selector used for selecting a range in the automatic mode.

### CROSS-REFERENCE TO RELATED APPLICATION

The present application claims priority under 35 U.S.C. § 119 to Japanese Patent Application No. 2024-155168, filed on Sep. 9, 2024, and Japanese Patent Application No. 2025-066122, filed on Apr. 14, 2025, the contents of which are incorporated herein by reference in their entirety.

### BACKGROUND

### Field

The present disclosure relates to a vehicle capable of switching a mode between a manual shift mode and an automatic mode.

### Background Art

JPH02-008545A discloses a shift device for an automatic transmission of a vehicle. The shift device comprises a shift lever, and a gear stage is selected by rotating the shift lever in a shift path.

### SUMMARY

A vehicle that has both a manual shift mode in which the driver can manually change a gear stage and an automatic mode in which the driver does not need to perform shift operation is considered. Requirements placed on the shift device may be different between the manual shift mode and the automatic mode.

The present disclosure relates to a vehicle capable of switching a mode between a manual shift mode in which a driver performs gear shift operation and an automatic mode in which the driver does not need to perform gear shift operation. The vehicle comprises an alternate type shift selector used for selecting a shift position in the manual shift mode and a momentary type shift selector used for selecting a range in the automatic mode.

According to the vehicle of the present disclosure, the shift position is selected by the alternate type shift selector in the manual shift mode, and the range is selected by the momentary type shift selector in the automatic mode. Although requirements placed on the shift selector are different between the manual shift mode and the automatic mode, the shift selector can be adapted to the requirements in each mode.

### BRIEF DESCRIPTION OF THE DRAWINGS

FIG. 1 is a diagram illustrating a configuration of an electric vehicle according to the embodiment of the present disclosure.

FIG. 2 is a diagram illustrating a configuration of a control device related to driving control of the electric vehicle.

FIG. 3 is a diagram illustrating an example of a shift selector in the first embodiment.

FIG. 4 is a diagram illustrating an example of the shift selector in a modified example of the first embodiment.

FIG. 5 is a diagram illustrating another example of the shift selector in the first embodiment.

FIG. 6 is a diagram illustrating still another example of the shift selector in the first embodiment.

FIG. 7A is a diagram illustrating an example of the shift selector in the second embodiment.

FIG. 7B is also a diagram illustrating an example of the shift selector in the second embodiment.

FIG. 8A is a diagram illustrating another example of the shift selector in the second embodiment.

FIG. 8B is also a diagram illustrating another example of the shift selector in the second embodiment.

FIG. 9A is a diagram illustrating an example of the shift selector in the third embodiment.

FIG. 9B is also a diagram illustrating an example of the shift selector in the third embodiment.

### DETAILED DESCRIPTION

### 1. Configuration of Power System of Electric Vehicle

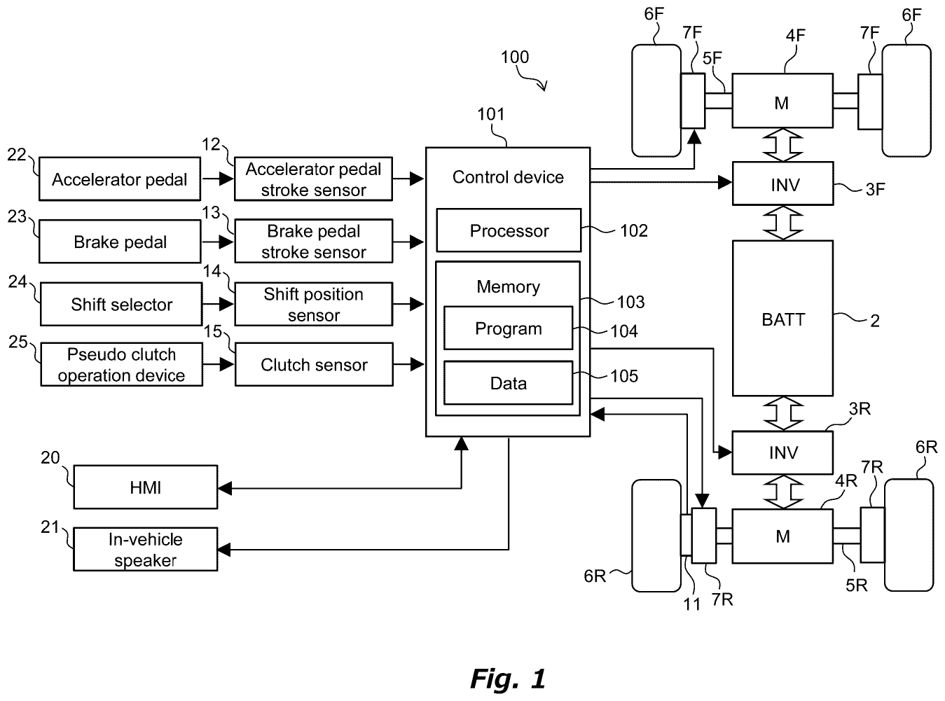

FIG. 1 is a diagram illustrating a schematic configuration of an electric vehicle 100 according to an embodiment of the present disclosure. First, the configuration of the power system of the electric vehicle 100 is described with reference to FIG. 1.

The electric vehicle 100 is equipped with two electric motors (M) 4F and 4R at the front and the rear, respectively, as power sources for driving the vehicle. The electric motors 4F and 4R are, for example, three-phase AC motors. The front electric motor 4F is connected to a front drive shaft 5F, which drives front wheels 6F. The rear electric motor 4R is connected to a rear drive shaft 5R, which drives rear wheels 6R. The front wheels 6F are suspended by front suspension 7F, in which the right and left can be controlled independently and electronically. The rear wheels 6R are suspended by front suspension 7R, in which the right and left can be controlled independently and electronically.

The front electric motor 4F and the rear electric motor 4R are respectively equipped with inverters (INV) 3F and 3R. The front inverter 3F and the rear inverter 3R are connected to a battery (BATT) 2, respectively. The battery 2 stores electric energy for driving the electric motors 4F and 4R. That is, the electric vehicle 100 is a battery electric vehicle (BEV) which is driven by electric energy stored in the battery 2. The inverters 3F and 3R are, for example, voltage type inverters which control the torque of the electric motors 4F and 4R by PWM control.

### 2. Control System and Control Mode of Electric Vehicle

Next, a configuration of a control system of the electric vehicle 100 is described with reference to FIG. 1.

The electric vehicle 100 is equipped with a control device 101. The control device 101 is connected to sensors and devices to be controlled that are mounted on the electric vehicle 100 via an in-vehicle network. The control device 101 includes at least a processor (processing circuit) 102 and a memory 103. The memory 103 includes a RAM for temporarily storing data, and a ROM for storing a program 104 executable by the processor 102 and various kinds of data 105 related to the program. The program 104 is composed of multiple instructions. The processor 102 reads the program 104 and the data 105 from the memory 103 and executes them, and generates a control signal based on a signal obtained from a sensor. The number of processors 102 and memories 103 included in the control device 101 may be one or more.

The control device 101 performs various controls on the electric vehicle 100. One or more programs 104 are read from the memory 103 and executed by the processor 102, thereby realizing control of the electric vehicle 100 by the control device 101.

Control of the electric vehicle 100 by the control device 101 includes driving control for controlling driving of the electric vehicle 100. In the driving control, the control device 101 can control the electric vehicle 100 in a plurality of control modes. The control modes of the electric vehicle 100 which can be selected by the control device 101 include an EV mode and an MT mode. The EV mode is a mode in which the electric motors 4F and 4R are controlled to have normal torque characteristics to drive the vehicle. The MT mode is a control mode for causing the electric vehicle 100 to operate like a manual transmission vehicle (MT vehicle). In the MT mode, the driver can use a shift selector 24, which will be described later, to perform virtual gear shift operation that simulates the gear shift operation (shift operation) of the MT vehicle and can select a virtual shift position.

The electric vehicle 100 is equipped with a human-machine interface (HMI) 20 as an interface with the driver. The HMI 20 is equipped with a touch panel display. The HMI 20 displays information on the touch panel display and receives input from the driver through touch operation on the touch panel display. The driver can select a control mode for the electric vehicle 100 from a selection screen displayed on the touch panel display of the HMI 20. Furthermore, the driver may be able to operate the touch panel display of the HMI 20 to select from a selection of options the engine characteristics, engine sound, suspension characteristics, etc. to be simulated in the MT mode.

The electric vehicle 100 is equipped with an in-vehicle speaker 21. The in-vehicle speaker 21 provides information to the driver by voice and is also capable of outputting a pseudo engine sound, which will be described later.

The electric vehicle 100 also includes a vehicle speed sensor 11. At least one of wheel speed sensors (not shown) provided on each of the left and right front wheels 6F and the left and right rear wheels 6R is used as the vehicle speed sensor 11.

The electric vehicle 100 is equipped with an accelerator pedal stroke sensor 12. The accelerator pedal stroke sensor 12 is provided on an accelerator pedal 22 and outputs a signal indicating the amount of depression of the accelerator pedal 22, i.e., the accelerator opening degree. Although the accelerator pedal 22 is a pedal-type device operated by the foot, the device for operating the accelerator may be a device operated by hand. For example, the electric vehicle 100 may be provided with a lever-type accelerator operation device or a dial-type accelerator operation device that is operated by hand instead of the accelerator pedal 22. These accelerator operation devices are also provided with sensors, which output signals indicative of the amount of operation, i.e., the accelerator opening.

The electric vehicle 100 is equipped with a brake pedal stroke sensor 13. The brake pedal stroke sensor 13 is provided on the brake pedal 23 and outputs a signal indicating the amount of depression of the brake pedal 23, that is, the brake opening degree.

The electric vehicle 100 also includes a shift selector 24. The shift selector 24 is provided, for example, on a console, and enables the driver to select a shift range or a virtual shift position by operating an operating member such as a shift lever, a dial, or a button. The shift selector 24 operates as a device for selecting a shift range while the EV mode is selected, and operates as a device for allowing the driver to perform a virtual gear shift operation while the MT mode is selected. In addition, the driver may be able to use a shift selector 24 in place of or in combination with the HMI 20 to switch between the EV mode and the MT mode. The shift selector 24 will be described in detail later.

The shift selector 24 is provided with the shift position sensor 14. The shift position sensor 14 detects the shift range (shift position) selected by the driver, and outputs a signal indicating the selected shift range (shift position).

Furthermore, the electric vehicle 100 is equipped with a pseudo clutch operating device 25. The pseudo clutch operation device 25 is a device for reproducing the clutch operation in a manual transmission vehicle. The operation of the pseudo clutch operating device 25 is enabled in the MT mode and disabled in the EV mode. However, the driver may be able to select between clutch operation and clutch less operation in the MT mode. Alternatively, when the shift selector 24 is used to switch the control mode, the operation of the pseudo clutch operating device 25 may be valid even in the EV mode.

An example of the pseudo clutch operating device 25 is a pseudo clutch pedal that simulates the clutch pedal of an MT vehicle. The pseudo clutch pedal is a dummy that is different from a real clutch pedal. The pseudo clutch pedal has a structure similar to that of a clutch pedal provided on a conventional MT vehicle. For example, the pseudo clutch pedal is equipped with a reaction force mechanism that generates a reaction force against the driver's depression. The position when no pedal force is applied is the starting position of the pseudo clutch pedal, and the position when the pedal is pressed all the way down is the ending position of the pseudo clutch pedal. The driver can operate the pseudo clutch pedal from the start position to the end position against the reaction force from the reaction mechanism. The pseudo-clutch operating device 25 may alternatively be a lever-type operating device or a dial-type operating device that is operated by hand.

The pseudo clutch operating device 25 is provided with a clutch sensor 15. The clutch sensor 15 outputs a signal indicating the amount of operation of the pseudo clutch operating device 25. When the pseudo clutch operating device 25 is a pseudo clutch pedal, the depression amount of the pedal is obtained as the operation amount of the pseudo clutch operating device 25. However, since the electric vehicle 100 does not have an actual clutch, the operation amount of the pseudo clutch operating device 25, i.e., the clutch opening degree, is a virtual clutch opening degree.

### 3. Driving Control of Electric Vehicle

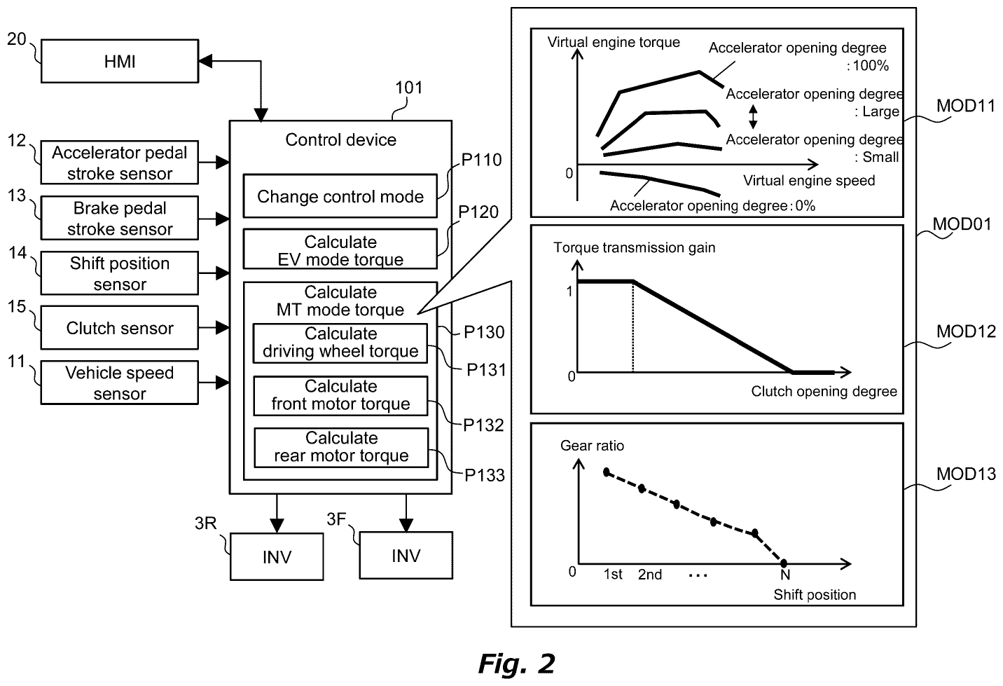

The control mode switched by the driver relates to the driving control of the electric vehicle 100. FIG. 2 is a diagram showing the configuration of a control device 101 related to driving control of the electric vehicle 100. In detail, FIG. 2 shows a configuration related to motor control, which controls the torque of the electric motors 4F, 4R, among other driving controls. The processor 102 executes one or more motor control programs 104 stored in the memory 103, causing the processor 102 to function as a motor control device.

A control mode signal is input from the HMI 20 to the control device 101 acting as a motor control device. The control mode signal contains information regarding the control mode selected by the driver. The control device 101 executes a process P110 based on the control mode signal. In process P110, the control mode is switched in accordance with the control mode signal. The control mode switching that particularly affects driving control is the switching between the EV mode and the MT mode.

When the control mode is switched to the EV mode, the control device 101 executes a process P120 for torque calculation in the EV mode. In process P120, the control device 101 obtains the vehicle speed from the signal of the vehicle speed sensor 11, and obtains the accelerator opening degree from the signal of the accelerator pedal stroke sensor 12. The control device 101 has a motor torque map with the accelerator opening and vehicle speed as parameters. The control device 101 inputs the vehicle speed and the accelerator opening into a motor torque map, and controls the inverters 3F, 3R so that the electric motors 4F, 4R generate the torque obtained from the motor torque map.

When the control mode is switched to the MT mode, the control device 101 executes a process P130 for torque calculation in the MT mode. Process P130 includes process P131 for calculating the torque to be generated at the drive wheels. Moreover, process P130 includes process P132 and process P133. The process P132 is a process for calculating the torque to be generated in the front electric motor 4F, and the process P133 is a process for calculating the torque to be generated in the rear electric motor 4R. Processes P132 and P133 are executed in accordance with the drive wheel torque calculated in process P130 and the torque distribution between the front wheels 6F and the rear wheels 6R.

The vehicle model MOD01 is used for calculating the drive wheel torque in process P131. The vehicle model MOD01 includes an engine model MOD11, a clutch model MOD12, and a transmission model MOD13. The engine virtually realized by the vehicle model MOD01 is referred to as a virtual engine, the clutch virtually realized is referred to as a virtual clutch, and the transmission virtually realized is referred to as a virtual transmission. In the engine model MOD11, a virtual engine is modeled. In the clutch model MOD12, a virtual clutch is modeled. In the transmission model MOD13, a virtual transmission is modeled.

The engine model MOD11 calculates a virtual engine speed and a virtual engine torque. The virtual engine speed is calculated from the vehicle speed, the overall reduction ratio, and the slip ratio of the virtual clutch. The virtual engine torque is calculated from the virtual engine speed and the accelerator opening. The vehicle speed is obtained from a signal of the vehicle speed sensor 11. The accelerator opening is obtained from a signal of the accelerator pedal stroke sensor 12. The overall reduction ratio is a value obtained by multiplying the speed ratio of the virtual transmission by the reduction ratio determined by the mechanical structure from the virtual transmission to the drive wheels. In the engine model MOD11, the relationship between the virtual engine speed and the virtual engine torque is defined for each accelerator opening. The engine characteristics of the engine model MOD11 may be selectable by the driver through the operation of the HMI 20.

The clutch model MOD12 calculates a torque transmission gain. The torque transmission gain is a gain for calculating the degree of torque transmission of the virtual clutch according to the clutch opening degree. When the clutch operation mode is selected, the clutch opening degree is obtained from the signal of the clutch sensor 15. The clutch opening is 0% at the start position of the pseudo clutch operating device 25 and is 100% at the end position of the pseudo clutch operating device 25. In the clutch model MOD12, a torque transmission gain is applied to the clutch opening. The torque transmission gain is converted into the clutch torque capacity of a virtual clutch, i.e., a virtual clutch torque capacity. Then, based on a comparison between the virtual clutch torque capacity and the virtual engine torque calculated by the engine model MOD11, a virtual clutch torque input from the virtual clutch to the virtual transmission is calculated. In addition, in the clutch model MOD12, a value obtained by subtracting a torque transmission gain from 1 is calculated as the slip ratio. The slip ratio is used in the calculation of the virtual engine speed in engine model MOD11.

When the clutch operation-less mode is selected, the clutch opening degree input to the clutch model MOD12 is calculated using a clutch operation model. The clutch operation model is a model that simulates the clutch operation of a model driver. The vehicle speed, the virtual engine speed, and a signal from the shift position sensor 14 are input to the clutch operation model.

The signal from the shift position sensor 14 is used to time the clutch operation. When a gear shift operation by the driver is detected by a signal from the shift position sensor 14, the clutch opening is maximized in the clutch operation model so as to disengage the virtual clutch. The vehicle speed and virtual engine speed are used to calculate the clutch opening. In order to smoothly match the rotation speed of the input shaft of the virtual transmission calculated from the vehicle speed with the virtual engine speed, the clutch operation model calculates the clutch opening based on the rotation speed difference between the rotation speed of the input shaft of the virtual transmission and the virtual engine speed.

The transmission model MOD13 calculates a virtual gear ratio. The virtual gear ratio is a gear ratio determined by a virtual shift position in a virtual transmission. The virtual gear ratio is set for each shift position. The maximum virtual gear ratio is set for first gear, and the virtual gear ratios decrease in the order of second gear, third gear, fourth gear,. The shift positions are in one-to-one correspondence with the signals of the shift position sensor 14.

The transmission model MOD13 calculates a virtual transmission torque using the virtual gear ratio and the virtual clutch torque. The virtual transmission torque is a virtual torque output from a virtual transmission. The control device 101 controls the inverters 3F, 3R so as to change the output torque of the electric motors 4F, 4R in accordance with the virtual transmission torque. The virtual transmission torque changes discontinuously in response to switching of the virtual gear ratio. This discontinuous change in virtual transmission torque generates a torque shock in electric vehicle 100, creating the impression that the vehicle is equipped with a stepped transmission.

The vehicle model MOD01 calculates the drive wheel torque from the virtual transmission torque and the reduction ratio. The drive wheel torque is the sum of the torques acting on the left and right front wheels 6F and the left and right rear wheels 6R. Torque distribution to the front wheels 6F and rear wheels 6R can be fixed or can be actively or passively varied. For example, the driver may be able to select a four-wheel drive mode in which all four wheels are driven, or a rear-wheel drive mode in which only the rear wheels are driven.

The vehicle model MOD01 is determined in advance. The relationship between the driving wheel torque calculated based on the vehicle model MOD01 and the accelerator opening degree changes when the virtual shift position is switched. In other words, in EV mode, the torque changes continuously with respect to the accelerator opening, whereas in MT mode, the relationship between the accelerator opening and the torque output from the electric motors 4F, 4R is switched to a relationship corresponding to a selected shift position from among multiple relationships predetermined by the vehicle model MOD01 when the virtual shift position is switched.

In process P132, the torque of the front electric motor 4F in MT mode (front motor torque) is calculated by multiplying the driving wheel torque calculated in process P131 by the torque distribution rate to the front wheels 6F and the reduction ratio from the output shaft of the front electric motor 4F to the front wheels 6F. The control device 101 controls the front inverter 3F so as to cause the front electric motor 4F to generate the front motor torque calculated in process P132.

In process P133, the torque of the rear electric motor 4R in MT mode (rear motor torque) is calculated by multiplying the drive wheel torque calculated in process P131 by the torque distribution rate to the rear wheels 6R and the reduction ratio from the output shaft of the rear electric motor 4R to the rear wheels 6R. The control device 101 controls the rear inverter 3R so as to cause the rear electric motor 4R to generate the rear motor torque calculated in process P133.

### 4. Sound Control of Electric Vehicle

The control device 101 may also perform sound control to control the sound emitted by the in-vehicle speaker 21. The processor 102 executes one or more sound control programs 104 stored in the memory 103, causing the processor 102 to function as a sound control device. The processor 102 functioning as the driving control device and the processor 102 functioning as the sound control device may be separate processors or may be the same processor.

The control device 101 as a sound control device can generate an artificially generated sound from the in-vehicle speaker 21. One of these artificial sounds is a pseudo engine sound that mimics the engine sound of a vehicle with a conventional transmission. When a control mode signal indicating that MT mode has been selected is input from the HMI 20, the control device 101 acting as a sound control device generates a pseudo engine sound based on the virtual engine torque and virtual engine speed calculated in process P131.

When the driver can select the engine sound, the engine sound selected by the HMI 20 is used as the sound source of the pseudo engine sound to be generated from the in-vehicle speaker 21. However, the sound of the sound source is not used as is. The sound pressure of the engine sound is calculated so that the sound pressure increases as the virtual engine torque increases, and the frequency of the engine sound is calculated so that the frequency increases as the virtual engine speed increases. Then, for example, the sound pressure of the sound source is changed by an amplifier, and the frequency of the sound source is changed by a frequency modulator, and the pseudo engine sound is reproduced from the in-vehicle speaker 21. The virtual engine torque and virtual engine speed change depending on the driver's accelerator operation, gear shift operation, and clutch operation. In this way, by changing the sound pressure and frequency of the pseudo engine sound according to the virtual engine torque and virtual engine speed which change in accordance with the driver's operation, it is possible to give the driver a sense of reality as if he or she were driving a vehicle with a real transmission.

### 5. Configuration of Shift Selector

### 5-1. First Embodiment

As described above, the shift selector 24 operates as a device for selecting a shift range in the EV mode, and operates as a device for selecting a virtual shift position in the MT mode. An example of the shift selector 24 in the first embodiment is shown in Fig.

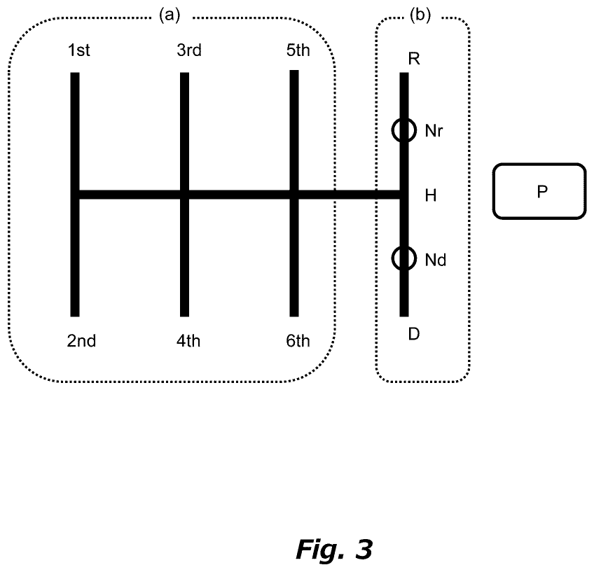

The shift selector 24 in FIG. 3 is a device in which a shift range or a shift position is associated with a predetermined physical position, and the physical position is selected by an operating member. The shift selector 24 has a shift lever as an operating member, and the driver can move the shift lever along a shift path between each shift range (shift position). The shift path in the EV mode and the shift path in the MT mode are integrated, and the same shift lever is used for both the EV mode and the MT mode.

The shift lever is in area (b) of the integrated shift path while the EV mode is selected. From that state, when the driver moves the shift lever to area (a) while satisfying the control mode switching conditions, the control mode switches to the MT mode. When switching from MT mode to EV mode, the operation is reversed. In other words, the shift selector 24 also serves as a device for switching between the EV mode and the MT mode.

The control mode switching condition may be any condition. For example, the switching condition may be that the driver operates the shift lever within a predetermined time after selecting the control mode switching by operating the HMI 20. Alternatively, the switching condition may be that the driver moves the shift lever while inputting an operation amount to the pseudo clutch operating device 25.

Furthermore, switching control modes does not just change the position of the shift lever. The behavior of the shift lever can also be switched depending on the control mode.

While the EV mode is selected, the shift lever is basically in the home position (H position). When the driver moves the shift lever to any of the R, Nr or Nd, and D positions, an operation is input and one of the reverse range, neutral range, and drive range is selected, but when the driver finishes the operation and releases his/her hand, the shift lever automatically returns to the home position. The parking range is selected by the driver by pressing a button. That is, in the EV mode, the lever is in the home position when not being operated by the driver, and does not indicate the state of the vehicle. In the EV mode, the current shift range is displayed on the meter panel, the HMI 20, etc.

In contrast, in MT mode, the shift lever remains in the shift position selected by the driver. For example, when the driver moves the shift lever to the first gear position, a signal is output indicating that first gear has been selected as the virtual shift position, and the shift lever remains in the first gear position until another operation is input thereafter. That is, in MT mode, the shift selector 24 accepts input regarding shift position and at the same time indicates the current shift position by the physical position of the shift lever.

The behavior of the shift selector 24 in the EV mode and the MT mode are sometimes called momentary and alternate modes, respectively. In other words, the shift selector 24 operates as a momentary type shift selector in the EV mode, and operates as an alternate type shift selector in the MT mode.

The effect of the shift selector 24 being configured to be switchable between the momentary type and the alternate type in this manner will be described.

Generally, in MT vehicles, an alternate type shift device is used for gear shifting. When changing the shift position while driving a manual transmission vehicle, the driver determines the current shift position from the feeling when touching the shift lever, instead of visually checking the position of the shift lever. Even in the MT mode of the electric vehicle 100, by allowing the shift position to be selected using an alternate type shift selector, the driver can grasp the current shift position by touching the shift lever without lowering his or her eyes. This improves operability for the driver. In addition, because the behavior can be made to resemble that of a typical MT vehicle, it is expected that the satisfaction of drivers who want to experience driving a MT vehicle will be high.

On the other hand, the electric vehicle 100 may be equipped with an assistance function for improving the convenience of the vehicle user, such as the driver, and the shift range may be controlled by the assistance function. For example, if the assistance function is an automatic parking brake, the shift range is automatically switched to the parking range when the vehicle is parked. Alternatively, if the assistance function is an automatic parking function, the reverse range and the drive range are automatically switched.

Such assistance functions may be disabled in MT mode. This is because a driver who selects the MT mode, which requires more operations than the EV mode, is highly likely to wish to perform driving operations himself/herself without relying on assistance functions. However, when the EV mode is selected, it is desirable to be able to utilize the assistance functions.

In EV mode, the shift range can be selected using a momentary shift selector, thereby preventing a discrepancy between the state physically indicated by the shift selector 24 and the actual state of the vehicle even when the assistance function is activated. For example, this can prevent a situation in which the shift lever is in the drive range even though the parking assistance has automatically switched to reverse range. In this way, confusion on the part of the driver caused by a discrepancy between the state indicated by the operating member and the state of the vehicle can be prevented, and the driver can easily grasp the state of the vehicle.

In this way, the shift selector 24 can accommodate the requirements in both the EV mode and the MT mode. In this way, the operability of the shift selector can be improved.

Also, in the example of FIG. 3, the alternate type shift selector used in the MT mode and the momentary type shift selector used in the EV mode are configured as an integrated shift selector 24, and one common operating member is used as the operating member for both the alternate type shift selector and the momentary type shift selector. Therefore, it is convenient for the driver because the driver can easily know whether the current control mode is EV mode or MT mode based on the position of the shift lever.

In the example of FIG. 3, the neutral position of the alternate type shift selector and the home position of the momentary type shift selector are connected together on the operating line of the shift lever. When switching the control mode from the MT mode to the EV mode, the driver must move the shift lever from the neutral position of the MT mode to the home position of the momentary shift selector. After switching to the EV mode, the shift lever first goes into the home position of the momentary shift selector. At this time, the shift range can be set arbitrarily. When switching the control mode from the EV mode to the MT mode, the driver needs to move the shift lever from the home position of the momentary shift selector to the neutral position on the alternate shift selector side. After switching to the MT mode, the shift lever is first placed in the neutral position, so that driving force is not transmitted to the wheels 6F, 6R until the driver selects one of the shift positions himself.

### 5-2. Modification of First Embodiment

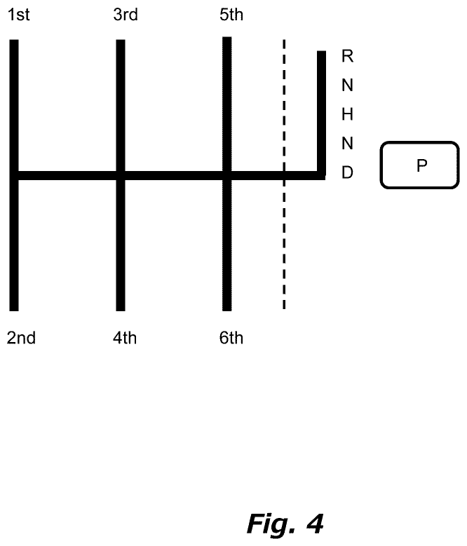

FIG. 4 shows a modification of the first embodiment. The shift path may be shaped as shown in Fig. As in FIG. 3, the alternate type shift selector and the momentary type shift selector are configured as an integrated shift selector, and when the shift lever is on the left side of the dashed line, the MT mode is selected, and when it is on the right side, the EV mode is selected. However, in the example of FIG. 4, the neutral position of the alternate type shift selector and the drive range of the momentary type shift selector are connected together.

### 5-3. Layout of Shift Path

In the example of FIGS. 3 and 4, the shift path of the shift selector 24 is configured so that the momentary shift selector used in the EV mode is disposed on the right side, and the alternate shift selector used in the MT mode is disposed on the left side. However, the arrangement of the momentary type shift selector and the alternate type shift selector is not limited to this arrangement.

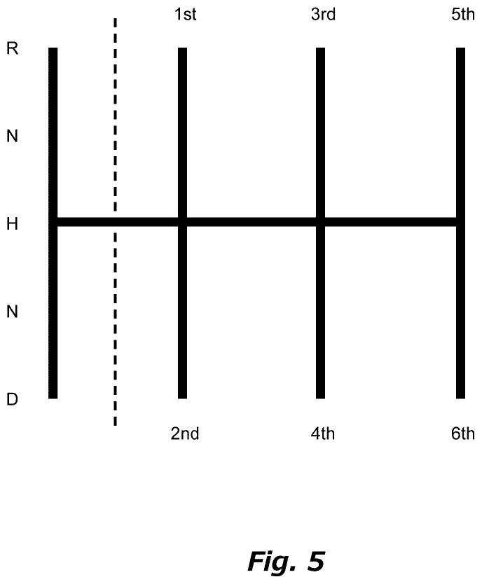

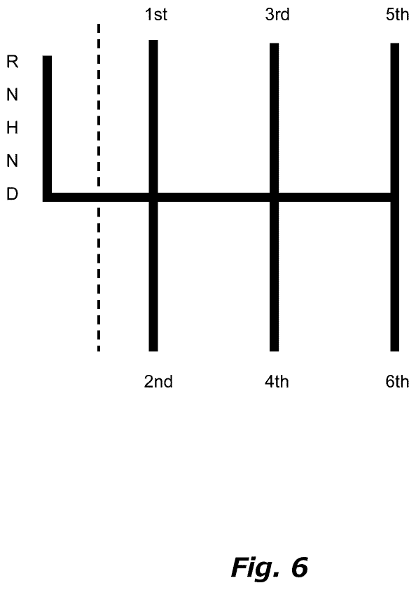

For example, the shift path of the shift selector 24 may be configured such that a momentary shift selector is located on the left and an alternate shift selector is located on the right. 5 and 6 show examples of the shift path of the shift selector 24 arranged in this way. In the example of FIG. 5, the neutral position of the alternate type shift selector and the home position of the momentary type shift selector are connected together. In the example of FIG. 6, the neutral position of the alternate type shift selector and the drive range of the momentary type shift selector are connected together. The behavior of the shift selector 24 is as explained above. The same shift lever is used for both the MT mode and the EV mode. When the shift lever is on the right side of the dashed line, the MT mode is selected, and when it is on the left side, the EV mode is selected. The shift selector 24 operates as an alternate type shift selector when the shift lever is located to the right of the dashed line, and operates as a momentary type shift selector when the shift lever is located to the left.

### 5-4. Second Embodiment

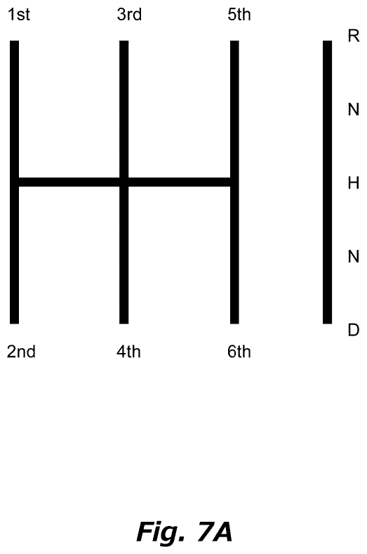

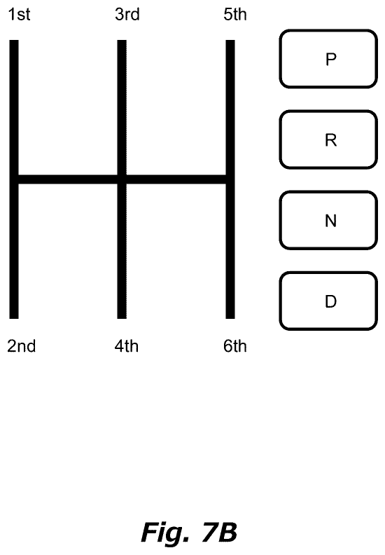

In the second embodiment, the shift selector 24 also includes an alternate type shift selector used in the MT mode and a momentary type shift selector used in the EV mode. However, the alternate type shift selector and the momentary type shift selector are configured as separate selectors. FIGS. 7A and 7B show two examples of the shift selector 24 in the second embodiment.

In the example of FIG. 7A, both the alternate type shift selector and the momentary type shift selector are configured to select a shift range (shift position) by moving a shift lever along a shift path. However, the shift paths are not connected and each has a different shift lever. In the example of FIG. 7B, the momentary shift selector is a button-type operating device. In the second embodiment, the shift selector 24 may also function as a control mode switching device. In this case, for example, the MT mode may be initiated when an alternate type shift selector is operated while the switching conditions are satisfied, and the EV mode may be initiated when a momentary type shift selector is operated while the switching conditions are satisfied. The effect of being able to switch between the alternate type and the momentary type is the same as in the first embodiment.

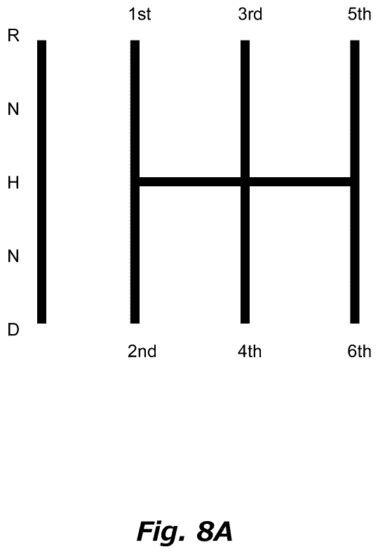

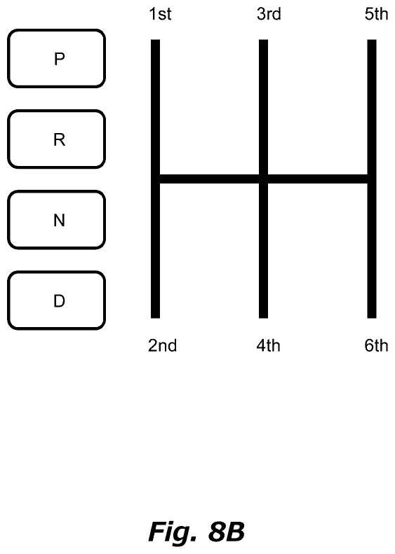

In the examples of FIGS. 7A and 7B, the alternate type shift selector is disposed on the left side and the momentary type shift selector is disposed on the right side, but in the second embodiment as well, the arrangement of the alternate type shift selector and the momentary type shift selector is arbitrary. FIGS. 8A and 8B show two examples of the shift selector 24 where the alternate type shift selector is located on the right side and the momentary type shift selector is located on the left side. In the example of FIG. 8A, both the alternate type shift selector and the momentary type shift selector are configured as devices for selecting a shift range (shift position) by moving a shift lever along a shift path. In the example of FIG. 8B, the momentary shift selector is a button-type operating device. The behavior of the shift selector 24 is similar to that in the examples of FIGS. 7A and 7B.

### 5-5. Other Embodiments

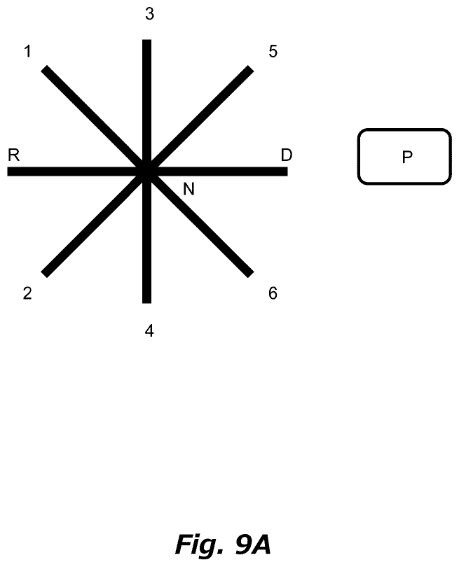

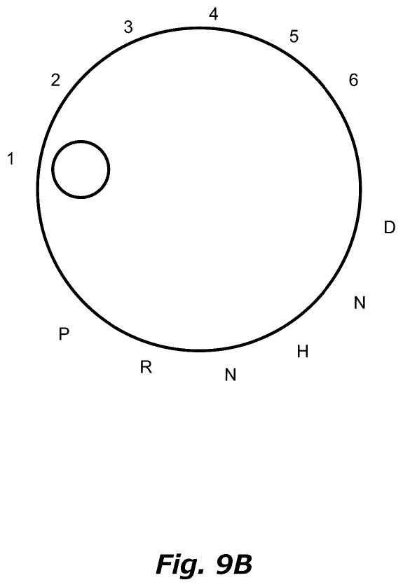

FIGS. 9A and 9B show examples of the third and fourth embodiments. In the third embodiment shown in FIG. 9A, the shift paths of the alternate type shift selector and the momentary type shift selector are in the same area. The shift selector 24 may be configured in this way. In the fourth embodiment shown in FIG. 9B, a dial is used as the operating member. The dial is common to both the alternate type shift selector and the momentary type shift selector. The shift selector 24 operates as an alternate type shift selector when the dial is in the upper position, and as a momentary type shift selector when the dial is in the lower position.

### 6. Modifications

The configuration of the shift selector 24 has been described above. In any of the first to fourth embodiments, the following modifications are possible. In other words, although the shift selector 24 has been described above as a device mounted on an electric vehicle, the shift selector 24 can be applied to vehicles other than electric vehicles as long as the vehicle is capable of switching the gear shift mode between an automatic mode in which no gear shift operation is required by the driver and a manual gear shift mode in which the driver performs the gear shift operation themselves. For example, the shift selector 24 may be applied to a semi-automatic transmission vehicle. In this case as well, the shift selector 24 is switched to a momentary shift selector in the automatic mode, and is switched to an alternate shift selector in the manual shift mode. In the electric vehicle 100, the EV mode corresponds to the automatic mode, and the MT mode corresponds to the manual shift mode.

What is claimed is

1. A vehicle capable of switching a mode between a manual shift mode in which a driver performs gear shift operation and an automatic mode in which the driver does not need to perform gear shift operation, comprising:
an alternate type shift selector used to select a shift position in the manual shift mode; and
a momentary type shift selector used to select a range in the automatic mode.

2. The vehicle according to claim 1, wherein
the alternate type shift selector is configured such that the shift position is selected by moving a first operating member,
the momentary type shift selector is configured such that the range is selected by moving a second operating member, and
a common operating member is used as the first operating member and the second operating member.

3. The vehicle according to claim 2, wherein
a neutral position of the alternate type shift selector and a home position of the momentary type shift selector are connected on an operation line of the common operating member.

4. The vehicle according to claim 1, wherein
the mode is switched to the manual shift mode when the alternate type shift selector is operated in the automatic mode, and
the mode is switched to the automatic mode when the momentary shift selector is operated in the manual shift mode.

5. The vehicle according to claim 1, comprising
an electric motor as a driving source;
an accelerator pedal; and
a control device for controlling the electric motor, wherein the control device is configured to,
in the automatic mode, continuously change output torque of the electric motor in response to operation of the accelerator pedal by the driver, and
in the manual shift mode, switch a relationship between an operation amount of the accelerator pedal and the output torque of the electric motor from among a plurality of relationships corresponding to virtual gear stages in response to the driver's operation of the alternate type shift selector.
